(19) United States
(12) Patent Application Publication
(10) Pub. No.: US 2023/0186070 A1
(43) Pub. Date: Jun. 15, 2023

(54) ARTIFICIAL INTELLIGENCE BASED DATA PROCESSING IN ENTERPRISE APPLICATION

(71) Applicant: NB Ventures, Inc., DBA GEP, Clark, NJ (US)

(72) Inventors: Subhash Makhija, Westfield, NJ (US); Nithin Maruthi Prasad, Avenel, NJ (US); Huzaifa Matawala, Princeton, NJ (US); Shivendra Singh Malik, Vasco-da-Gama (IN)

(21) Appl. No.: 17/547,795

(22) Filed: Dec. 10, 2021

(51) Int. Cl. G06N 3/08; G06Q 30/00

(52) U.S. Cl. CPC G06N 3/08; G06Q 30/0185

(57) ABSTRACT

The present invention provides an artificial intelligence-based data processing system and method for enterprise application. The data processing system and method are configured to receive an input data for executing a task at a server, identify and fetch one or more outliers from a data network based on the task to be executed, process the one or more outliers by at least one outlier data model trained on a historical outlier dataset to identify one or more glitches in execution of the task and in response to the recommended action, determine by at least one path identifier data model, at least one path for execution of an action.

### BACKGROUND

### 1. Technical Field

The present invention relates generally to artificial intelligence (AI) based operations in enterprise applications. More particularly, the invention relates to systems, methods and computer program product for data processing to manage approvals related to one or more operations of an enterprise application.

### 2. Description of the Prior Art

Any enterprise application executing multiple functions processes distinct datasets to determine the most efficient way of processing data. Depending on the complexity of the function of an enterprise application say like a contract management function of a supply chain management application, the data processing capabilities of a computing system is challenged every time. For e.g., in case of a contract management function, the system may need to execute approval of certain clause by an entity or a user party to the contract. In such a scenario, not only the availability of the approver is essential but also multiple other supporting aspects needs to be considered which are not processed otherwise. Moreover, the approval may be dependent on execution of multiple sub-processes where each clause may be dependent on execution of another clause by a different user, however, the system only processes limited parameters and may not consider other dependent parameters due to computing inefficiency and oversight.

Also, the real time alterations in functions may impact not only the approval flow but other critical decision parameters. The data processing systems are not capable of determining the glitches arising out of the alterations. The impact of such real time alterations may lead to inefficient functioning and wastage of precious time.

In case of a decentralized system, the function such as contract management, invoice processing, purchase order, etc., presents multiple challenges like security vulnerabilities, privacy leakage, complicated authorization and workflow inefficiencies. Further, blockchain implemented systems present other unique challenges. Data processing in complex supply chain management systems with blockchain built sub-systems, present substantive technical challenges including executing blockchain transactions and contracts. Such data processing systems require frequent access to and interaction with blockchain network, which is not only costly but also resource consuming. Executing any operation such as creating a dynamic approval flow in a blockchain implemented system is extremely complex requiring processing of data at multiple data layers. Further, the blockchain implemented systems require specific security structure to enable secured access while executing any task.

In view of the above problems, there is a need for system and method of data processing for managing one or more operations of an enterprise application that can overcome the problems associated with the prior arts.

### SUMMARY

According to an embodiment, the present invention provides a system and a method for artificial intelligence-based data processing in an enterprise application. The data processing system includes one or more processors, at least one memory device coupled to the one or more processors enabling the one or more processors to receive an input data for executing a task at a server, identify and fetch by the one or more processor coupled to an artificial intelligence (AI) engine, one or more outliers from a data network based on the task to be executed wherein a bot utilizes a library of functions stored in a functional database to generate one or more data scripts usable by the one or more processors to identify the outliers, process the one or more outliers by at least one outlier data model trained on a historical outlier dataset to identify one or more glitches in execution of the task and recommend at least one action to obviate the one or more glitches for executing the task, and in response to the recommended action, determine by at least one path identifier data model, at least one path for execution of the action wherein the path identifier data model is trained on a historical execution path dataset to create an autogenerated execution path.

In an embodiment, the outliers include deviations in system such as absence of documents, rearrangement of processing sequence, absence of authorized approver, absence or error in verification of security certificates etc.

In an embodiment, the recommended action includes an alternate approver to execute an approval flow task in the enterprise application, an alternate approval path based on the learning from the historical data, correcting processing of transactions based on analysis of the rearranged processing sequence, identifying and fetching an absent document from different data source through the data network, and verifying security certificates based on historical data from the blockchain network.

In an embodiment, the present invention provides a non-transitory computer-readable storage medium coupled to one or more processors and having instructions stored thereon which, when executed by the one or more processors, cause the one or more processors to perform a data processing method in an enterprise application.

In an advantageous aspect, the system and method of the present invention enables identifying one or more outliers in an entire approval path. For E.g., Outliers in the path of a document, if the user is not in the system anymore, then a warning message will be sent to the document author about this impending issue and provide recommendations. The invention has a strong connection with the data network to predict document’s approval based on any upstream changes to documents. For E.g., if a person is creating a contract with type MSA (Master services agreement), then the AI engine is configured to predict that for an invoice which will be created based on this contract type, the contact value should be of a certain amount for the qualifying supplier. This is to denote that in case of any changes for a document across the data network, the AI engine would be able to predict what issues might come. Further, the system is configured to determine an expected approval time for a document based on multi-variable matrix like approval availability, time takes by each approver etc. The data models are trained by weightage of each user based on their past performance.

In another embodiment, the system of the present invention is configured to determine the shortest or least resistant path, by assigning a weightage to each step in the flow. The AI engine determines the connections between pair of data elements or nodes and each path connection is called an edge. Based on the weightage for each node and edge the AI engine is configured to determine the shortest path to reduce the time taken for execution of approvals.

In yet another embodiment, the data processing system includes a blockchain network having one or more data blocks connected to each other and configured for storing SCM application data; and an integrator configured to integrate the AI engine with one or more external entity systems through the blockchain network, wherein a transaction through the blockchain network is encrypted using a random number and the approval mechanism in the one or more SCM application functions is executed through the blockchain network.

In an advantageous aspect, the present invention utilizes Machine Learning algorithms, prediction data models, neural network and data analysis for identifying outliers and execution paths.

### BRIEF DESCRIPTION OF THE DRAWINGS

The disclosure will be better understood and when consideration is given to the drawings and the detailed description which follows. Such description makes reference to the annexed drawings wherein:

FIG. 1 is a view of a data processing system of an enterprise application in accordance with an embodiment of the invention.

FIG. 1A is a view of an architecture diagram of the data processing system in accordance with an example embodiment of the invention.

FIG. 1B is a blockchain implemented data processing system in accordance with an embodiment of the invention.

FIG. 1C is a block diagram of a document data network of the data processing system in accordance with an embodiment of the invention.

FIG. 2 is a flowchart depicting a data processing method for executing a task in an enterprise application in accordance with an embodiment of the invention.

FIG. 2A is a flowchart depicting a data processing method with data classification in accordance with an embodiment of the invention.

FIG. 3 is a neural network of the data processing system in accordance with an embodiment of the invention.

FIG. 4 is a table showing an output of the neural network in accordance with an embodiment of the invention.

FIG. 5 is a graph network showing the paths from each node of the network in accordance with an embodiment of the invention.

FIG. 6 is a table showing shortest path for reaching from one node of the graph network to another node in accordance with an embodiment of the invention.

FIG. 7 is a data network with contract lifecycle management function data objects and nodes of the enterprise application in accordance with an example embodiment of the invention.

### DETAILED DESCRIPTION

Described herein are the various embodiments of the present invention, which includes data processing method and system for managing approvals related to one or more operations in an enterprise application for supply chain management.

The various embodiments including the example embodiments will now be described more fully with reference to the accompanying drawings, in which the various embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, the sizes of components may be exaggerated for clarity.

It will be understood that when an element or layer is referred to as being “on,” “connected to,” or “coupled to” another element or layer, it can be directly on, connected to, or coupled to the other element or layer or intervening elements or layers that may be present. As used herein, the term “and/or” includes any and all combinations of one or more of the associated listed items.

Spatially relative terms, such as “data attributes,” “objects,” or “elements,” and the like, may be used herein for ease of description to describe one element or feature’s relationship to another element(s) or feature(s) as illustrated in the figures. It will be understood that the spatially relative terms are intended to encompass different orientations of the structure in use or operation in addition to the orientation depicted in the figures.

The subject matter of various embodiments, as disclosed herein, is described with specificity to meet statutory requirements. However, the description itself is not intended to limit the scope of this patent. Rather, the inventors have contemplated that the claimed subject matter might also be embodied in other ways, to include different features or combinations of features similar to the ones described in this document, in conjunction with other technologies. Generally, the various embodiments including the example embodiments relate to a system and method for managing approval related to one or more operations in an enterprise application for supply chain management.

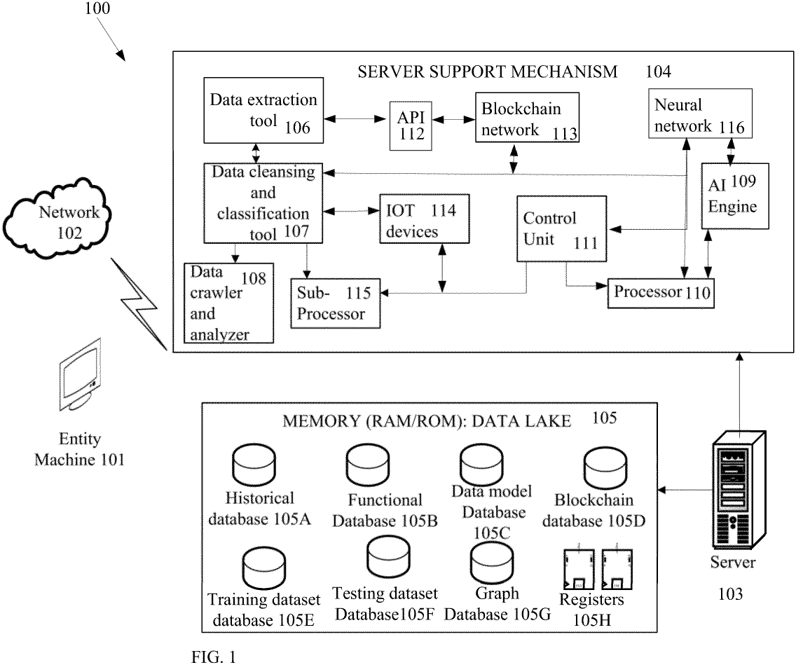

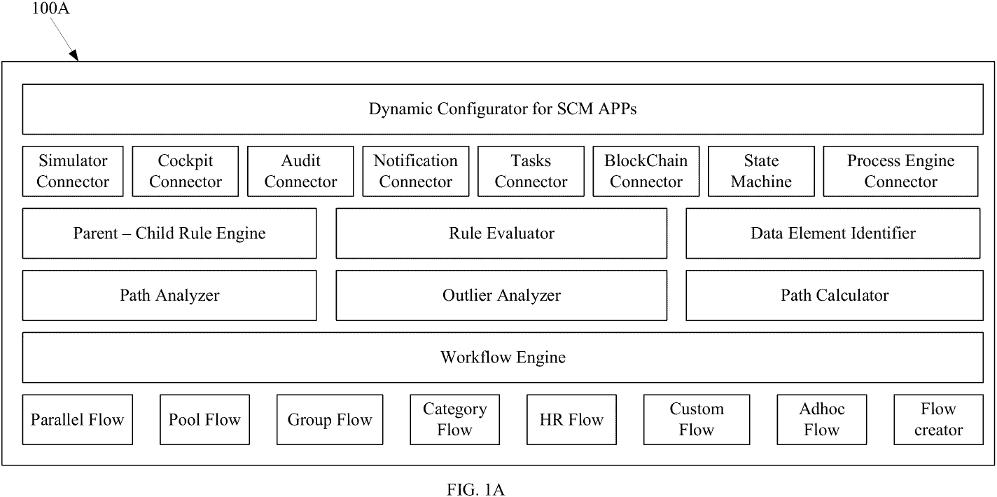

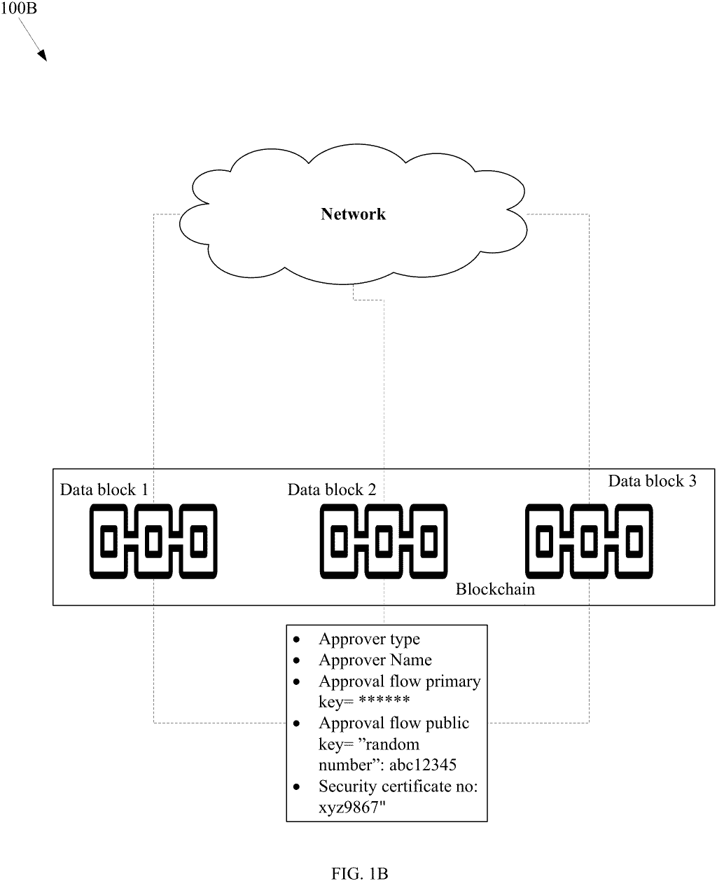

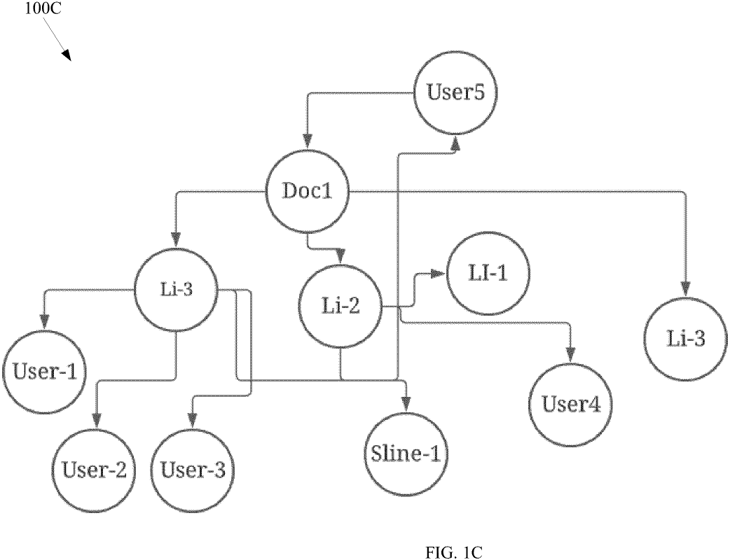

Referring to FIG. 1, a data processing system 100 for managing one or more operations in an enterprise application is provided in accordance with an embodiment of the present invention. The system 100 includes at least one entity machine 101 with a user interface for sending, receiving, modifying or triggering processing of one or more datasets over at least one network 102. The system includes a server 103 configured to receive data and instructions from the entity machine 101. The system 100 includes a support mechanism 104 for performing prediction, data processing and analysis, workflow creation and management, and approval process with multiple functions including historical dataset extraction, classification of historical datasets, artificial intelligence-based processing of new datasets and structuring of data attributes for analysis of data, creation of one or more data models configured to process different parameters. The system 100 includes a data store/data lake 105 for accessing item or services or user or task related data, dataset characteristic related historical data, and storing plurality of training data models created by support mechanism 104.

In an exemplary embodiment, the user interface of the entity machine 101 enables cognitive computing to improve interaction between user and an enterprise or supply chain application(s). The interface improves the ability of a user to use the computer machine itself. Since, the interface provides actionable insights into various category of enterprise application functions/operation including but not limited to dataset characteristic conveying outliers, functional disruption, operational advancement, changes to approver information, approval flow with different organizational departments, graphical representation of data network nodes in the approval flow etc., at the same instant, the interface thereby enables a user to take informed decision or undertake an appropriate strategy for adjusting execution of the task. The user interface triggers a plurality of approval execution paths. By eliminating multiple layers, processing tasks and recordation of information to get a desired approval flow with fastest execution, which would otherwise be slow, the user interface is more user friendly and improves the functioning of the existing computer systems.

In an embodiment the entity machine 101 may communicate with the server 103 wirelessly through communication interface, which may include digital signal processing circuitry. Also, the entity machine 101 may be implemented in a number of different forms, for example, as a smartphone, computer, personal digital assistant, or other similar devices.

In an embodiment the server 103 of the invention may include various sub-servers for communicating and processing data across the network 102. The sub-servers include but are not limited to content management server, application server, directory server, database server, mobile information server and real-time communication server.

In example embodiment the server 103 shall include electronic circuitry for enabling execution of various steps by processor. The electronic circuity has various elements including but not limited to a plurality of arithmetic logic units (ALU) and floating-point Units (FPU’s). The ALU enables processing of binary integers to assist in identification of outliers and shortest execution path for enabling execution of task including approval task associated with a plurality of supply chain management functions. In an example embodiment the server 103 electronic circuitry includes at least one Athematic logic unit (ALU), floating point units (FPU), other processors, memory, storage devices, high-speed interfaces connected through buses for connecting to memory and high-speed expansion ports, and a low-speed interface connecting to low-speed bus and storage device. Each of the components of the electronic circuitry, are interconnected using various busses, and may be mounted on a common motherboard or in other manners as appropriate. The processor can process instructions for execution within the server 103, including instructions stored in the memory or on the storage devices to display graphical information for a graphical user interface (GUI) on an external input/output device, such as display coupled to high-speed interface. In other implementations, multiple processors and/or multiple busses may be used, as appropriate, along with multiple memories and types of memory. Also, multiple servers may be connected, with each server providing portions of the necessary operations (e.g., as a server bank, a group of blade servers, or a multi-processor system).

In an example embodiment, the system 100 of the present invention includes a back-end web server communicatively coupled to at least one database server, where the back-end web server is configured to process the input data based on one or more data models and determining an action to mitigate one or more identified glitches in execution of a task by a recommendation engine and applying an AI based dynamic processing logic to recommendation engine to automate tasks.

In an example embodiment, the support mechanism 104 of the system 100 includes a control interface for accessing dataset characteristics related information received at the server 103. The support mechanism 104 enables identification and processing of outliers from received inputs to identify one or more glitches in execution of the task. Further, the artificial intelligence (AI) based system 100 enables codeless development of functions with support mechanism 104 providing configurable components, that run independently as well as interdependently from each other depending on the operation to be executed, while exchanging data.

The support mechanism 104 includes a data extraction tool 106 configured for extracting data attributes from one or more received input data, a data cleansing and classification tool 107 for cleansing, normalization and classification of historical data related to supply chain application including the received input data. The historical data includes historical outlier data and one or more historical execution path data. The support mechanism 104 also includes a data crawler and analyzer 108, an AI engine 109, one or more processors 110, a control unit 111, an API 112, a blockchain network 113, a plurality of IOT devices 114, a plurality of sub-processors 115, and a neural network 116.

In an embodiment, the data crawler and analyzer 108 is coupled to the one or more processor 110 and configured for analyzing one or more documents related to the SCM application function to identify a plurality of data items of the one or more documents requiring approvals for executing the function wherein each of the plurality of data items have an approval flow such that an outcome of the approval flow of a first data item of the plurality of data items impacts the approval flow of a second data item of the plurality of data items.

The AI engine 109 integrates deep learning, predictive analysis, information extraction, planning, scheduling, impact analysis and robotics for analysis of the received input data to identify the outliers from the data network. The one or more processors 110 is configured to identify an approval type based on the data items wherein the data items are structured in a hierarchy and the approval type is identified as single approval type or multi-approver type by the AI engine 109 based on one or more configured processing rules.

In an embodiment, the present invention uses GPUs (Graphical processing units) for enabling AI engine 109 to provide computing power to processes humongous amount of data to structure the data processing system.

In an exemplary embodiment, the AI engine 109 employs machine learning techniques that learn patterns and generate insights from the data for enabling identifying relationships of data attribute of the data with one or more data elements of the historical data and automate operations. Further, the AI engine 109 with ML employs deep learning that utilizes artificial neural networks to mimic neural network. The artificial neural networks analyze data to determine associations and provide meaning to unidentified or new data.

In an exemplary embodiment, the support mechanism 104 includes a plurality of data processing bots configured to automate data extraction, data analysis, outlier determination, shortest execution path for related approval flow as processing tasks. The support mechanism 104 may include hardware components or software components or a combination of hardware and software components integrating multiple data objects through one or more applications implemented on a cloud integration platform.

In an embodiment, the software component as a bot may be a computer program enabling an application to integrate with distinct data source devices and systems by utilizing Artificial intelligence. The hardware includes the memory, the processor, control unit and other associated chipsets especially dedicated for performing recalibration of data models to carry out data extraction, classification, outlier determination, approval flow execution in the EA when triggered by the bots. The memory may include instruction that are executable by the processor for causing the processor to execute the method of AI based data processing in EA.

The processor 110 is configured to determine fraud based on processing of the received input by the AI engine 109 through a fraud detection algorithm. The processor 110 may be implemented as a chipset of chips that include separate and multiple analog and digital processors. The processor 110 may provide coordination of the other components, such as controlling user interfaces, applications run by devices, and wireless communication by devices.

In an embodiment, the fraud detection is accomplished in multiple scenarios. For example, the system can cater to external approvals as well like a pre-authorization for an invoice that you create, from a third-party payment system. The third-party is part of active ledger (blockchain) and in this way the system would be able to establish trust with internal and external parties. Approvals are the last line of defense when it comes to real world money being shared within people, so making sure that there is no fraud or there is no one gaming the system [ for a contract value x, there should not be a user who is creating more payment requests which would eventually be x+1 for our customer]. Along with this, our custom code deployed to the blockchain system would be able to identify is an approval decision can be taken by the node itself rather than going to the connecting service. For example, if an order is ready to be flipped to an invoice, and this requires pre-authorization from an external party, this would go via our block chain. The BC would be able to decide whether the approval can be auto-processed based on our AI model and a combination of pre-auth rules from the payment service.

The Processor 110 may communicate with a user through control interface and display interface coupled to a display. The display may be, for example, a TFT LCD (Thin-Film-Transistor Liquid Crystal Display) or an OLED (Organic Light Emitting Diode) display, or other appropriate display technology. The display interface may comprise appropriate circuitry for driving the display to present graphical and other information to an entity/user. The control interface may receive commands from a user and convert them for submission to the processor. In addition, an external interface may be provided in communication with processor 110, so as to enable near area communication of device with other devices. External interface may provide, for example, for wired communication in some implementations, or for wireless communication in other implementations, and multiple interfaces may also be used.

In an embodiment, the data network is a graphical data network configured to process a plurality of data models including but not limited to document data model, relationship data model and graphical data model wherein the AI engine 109 coupled to the processor 110 is configured to enable the network to provide one or more outliers based on the task to be executed.

In a related embodiment, the data network includes one or more data element nodes configured to create one or more sub-network through a graphical data structure wherein one or more data elements are extracted from one or more data objects for analysis to identify the one or more data elements to be ingested as one or more data element node of the data network. The data network also includes one or more data connectors of the graphical data structure configured for connecting the one or more data element node to form the data network wherein the one or more data connectors include at least one identifier configured to identify the one or more data element node of the data network based on at least one relationship between one or more data attributes associated with the one or more data object and one or more historical data element, wherein the one or more data connectors include information about the at least one outlier.

In an embodiment, the data network includes a linkedchain and graphchain connector for integrating blockchain like services with the one or more SCM application and interaction with one or more data objects in the EA. Further, Configurator services are used to include third party networks or data sources managed by domain providers.

In an embodiment, the control unit 111 is encoded with instructions enabling the control unit to function as a bot for processing the approval flow to execute the SCM function wherein the plurality of data items for approvals creates a parent-child approval flow. The parent-child approval flow includes distinct weightage dynamically assigned by the AI engine to each of the one or more child approval flow node thereby enabling the one or more processor to process the approval flow with the shortest approval path wherein one or more approval constraint associated with each of the one or more child approval flow node decides execution of the SCM function. The one or more approval constraint includes approval data attributes associated with one or more approvers of the parent-child approval flow determining probability of receiving an approval from the one or more approvers. Further, the control unit 111 processes the approval flow based on a dynamic processing logic which may include serial, parallel or switching based processing logic for faster execution of the approval tasks.

The support architecture 104 includes a plurality of API (application programming interface) 112 configured for plugging aspects of AI (Artificial Intelligence) into datasets for identifying outliers and shortest execution path for the task including approvals. Further, the API is also consumed by the bots and mobile applications.

The support architecture 104 includes the blockchain network 113 having one or more data blocks connected to each other and configured for storing SCM application data. Also, the architecture includes an integrator configured to integrate the AI engine with one or more external entity systems through the blockchain network 113, wherein a transaction through the blockchain network 113 is encrypted using a random number and the approval mechanism in the one or more SCM application function is executed through the blockchain network 113. Further, the blockchain network 113 comprises a plurality of blockchain node layers where the node layers include a client node layer, a server node layer and a plurality of data network node layers.

In an embodiment, the support architecture 104 includes the one or more IOT devices 114 configured to provide the inputs to the server on initiation of the SCM action wherein the IOT devices include sensor, mobile, camera, Bluetooth, RF tags and similar devices or combination thereof. Further, the inputs may include but is not limited to outliers associated with inventory management data or warehouse management data or data related to one or more item for procurement etc.

In a related embodiment, support architecture 104 also includes the sub-processor 115 configured for processing the received input data by analyzing before mapping with the historical data related to supply chain and historical outliers. The mapping of the historical data is executed by a bot through a data mapping script. The support architecture includes the neural network 116 configured for data classification to train at least one outlier data model and at least one path identifier data model.

Referring to FIG. 1, the various elements like the support mechanism 104, the memory data store 105 are shown as external connections to the server 103 in accordance with an embodiment of the invention. However, it shall be apparent to a person skilled in the art that these elements may be part to an integrated server system. Also, some of the sub-elements of the support mechanism 104 and the memory data store 105 either alone or in various combinations may be part of a server system as other external connections.

In an example embodiment, the memory data store 105 includes plurality of databases as shown in FIG. 1. The data store 105 includes a historical database 105A for storing historical data including but not limited to historical outlier data, historical path identifier data, historical data with identifier information and relationship information defining a relationship of one or more data elements with each other as part of a data network, historical approval flow data, historical documents data with plurality of data items requiring approvals for executing a SCM function etc. The historical database 105A also includes classified historical data related to one or more document, file or function executed through the enterprise application. The historical data may include data from one or more nodes of the data network depending on the complexity of the functions to be executed. For e.g.: the historical database may include data related to past PO (Purchase order), supplier data, Inventory data, Warehouse data, etc. The one or more processors 110 are configured for performing one or more processing task associated with one or more data scripts generated by bots for identifying the outliers by utilizing a library of functions stored on a functional database 105B. Further, one or more data scripts also enable mapping of received data object related to SCM action, to historical data by processing at least one data attribute associated with received input data based on a dynamic processing logic.

In an embodiment, the system 100 of the present invention provides a historical database configured for storing historical data where the connections of the data in the database are structured on AI based model-driven flows incorporating reference to one or more identifiers to link the data within supply chain.

The data store 105 includes a data model database 105C having one or more data models including but not limited to graph data models trained on graph structures for semantic queries with nodes, edges and properties to represent and store data, the data models database 105C also includes a plurality of training models required to process the received input data for identifying relationship of outliers with historical data stored in the historical database 105A, the data model database 105C also includes relational data model, document data model as relationship models for identification of relationships in a training model database such as data model database 105C. Further, the data model database 105C stores a plurality of data models configured for cleaning and normalization of one or more data received from multiple data sources including internal data sources of enterprise as well as any other external data source like a third-party data source. The data model database 105C includes one or more outlier data model and one or more path identifier data model. The data store 105 also includes a blockchain database 105D having one or more sub-databases configured for storing approver and approval flow data related to approval of one or more tasks in supply chain application. The approver data includes approver identifier data such as internet protocol (IP) address, security certificate data etc., and the approval flow data includes approval flow public key, approval flow primary key, to ensure secured communication through the blockchain network for executing the task.

The data store/data lake 105 includes a training dataset database 105E and a testing dataset database 105F for storing training data and testing data obtained from the historical data. The prediction data for the testing data set is generated using the training data set through the one or more data models. The data store 105 also includes a graph database 105G configured to store nodes and relationships. The graph database 105G is a specialized, single-purpose platform for creating and manipulating graphs. Graphs contain nodes, edges, and properties, all of which are used to represent and store data.

The data store 105 also includes a plurality of registers 105H as part of the memory data store 105 for temporarily storing data from various databases to enable transfer of data by the processor 110 between the databases as per the instructions of the AI engine 109 to enable processing of received input data to identify relationship between one or more data elements of the received input data and historical data before storing the input data as part of the data network with identifiers to enable fetching of the input data on receiving an instruction from the computing device.

In an exemplary embodiment, the data store 105 includes one or more connector identifier databases including but not limited to a linkedchain connector identifier database, a graphchain connector identifier database for storing identifiers related to data stored in linkedchain implemented data source architecture platform and graphchain implemented data source architecture platform.

In a related embodiment, the processes of analyzing input data, identifying relationship of data elements of the input data, processing of data attributes of the input data, mapping of input data with historical classified data related to outliers, connecting the input data with node of the data network in real time, etc., are processed by one or more data scripts for automating the tasks. The data scripts are backend scripts created by the bot based on the attributes of the data objects and AI processing for enabling automation of the processing tasks.

The memory data store 105 may be a volatile, a non-volatile memory or memory may also be another form of computer-readable medium, such as a magnetic or optical disk.

The memory store 105 may also include storage device capable of providing mass storage. In one implementation, the storage device may be or contain a computer-readable medium, such as a floppy disk device, a hard disk device, an optical disk device, or a tape device, a flash memory or other similar solid-state memory device, or an array of devices, including devices in a storage area network or other configurations.

In an exemplary embodiment, the data store 105 is configured for storing historical data of documents related to operations including inventory management, delivery management, transportation management, work order management, demand and supply planning, forecast, purchase order and invoice, real-time streams from manufacturing devices and consumer preference in regions, feeds from weather, social sentiments, economic and market indices.

The computing devices referred to as the entity machine, server, processor etc. of the present invention are intended to represent various forms of digital computers, such as laptops, desktops, workstations, personal digital assistants, and other appropriate computers. Computing device of the present invention further intend to represent various forms of mobile devices, such as personal digital assistants, cellular telephones, smartphones, and other similar computing devices. The components shown here, their connections and relationships, and their functions, are meant to be exemplary only and are not meant to limit implementations of the inventions described and/or claimed in this disclosure.

In an embodiment, the received one or more input data is a document or a text data or a voice data or an image data. The data elements or data attributes include elements or attributes associated with content of the one or more input data. Further, the one or more data elements stored in the historical database includes historical data sets with relationships.

In an embodiment, the at least one data source includes a master data, inventory, order, RFX, ASN, supplier, contracts, user, IOT device, invoice retailers, suppliers, demand drivers, distributers, clients, logistics companies, third party manufacturers or mobile and IOT device management companies, channel & marketing partners, customer feedback collectors including social sentiments, survey management companies, entities including sales data, sensors data from manufacturing plant, sensors bit info from logistics, sensors data from warehouse management on item location, item tracker entities, feedback from end customers through bloggers, feedback data from channel partners, purchase Order data from enterprise systems, invoices and sales order from customers, external entities including global economy, market indices details, inventory stock from warehouse, contract management, shipping notes, invoice, sourcing, or any data generating module associated with a supply chain function of an enterprise application (EA). The data source provides district class of data to the data processing system for enabling the AI engine to process the data for executing a task such as approvals in various functions of the EA.

In an embodiment, the at least one data source is a linkedchain implemented data source or a graphchain implemented data source with a plurality of decentralized RDF (resource data framework) graphs connected to each other and structuring a linkedchain of the RDF graphs thereby providing a self-scaling and self-regulated cross-verifying transaction framework as the graphchain disseminates the data objects in data shards between multiple nodes in the RDF graph.

Referring to FIG. 1A, an architecture diagram 100A of the data processing system is provided in accordance with an embodiment of the invention. The layered architecture diagram shows a plurality of blocks including dynamic configuration for supply chain management (SCM) applications, simulator connector, cockpit connector, audit connector, notification connector, task connector, blockchain connector, state machine, process engine connector, Parent child rule engine, rule evaluator, data element identifier, path analyzer, outlier analyzer, path calculator. The architecture also includes workflow engine, parallel flow, pool flow, group flow, category flow, HR flow, custom flow, adhoc flow, and flow creator.

Referring to FIG. 1B, a blockchain implemented data processing system 100B is provided in accordance with an embodiment of the invention. The blockchain implemented system enables connection of one or more client nodes with one or more server nodes through the blockchain network.

Referring to FIG. 1C, a block diagram 100C of a document data network of the data processing system is shown in accordance with an example embodiment of the invention. The document data network block diagram 100C provides Ledgers as Doc1 - Document name, LI -Line Item, User - Username, Sline - Subline line item. The documents in the data processing system, have multiple line items as the data items that are utilized by the users. Every line item can have a subline item and each subline item will have an independent approval triggered for it. When the approval is triggered, there might be single/multiple users identified who would take action on this line/subline item. The users who have been identified for one line-item can be shared with other items and as depicted in the diagram 100C.

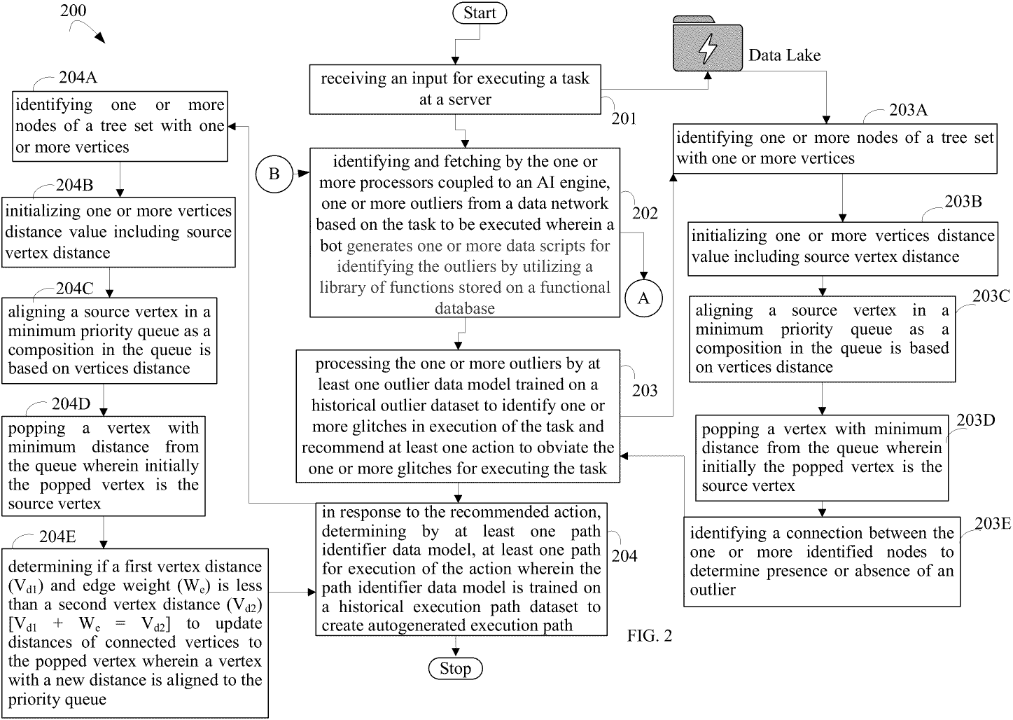

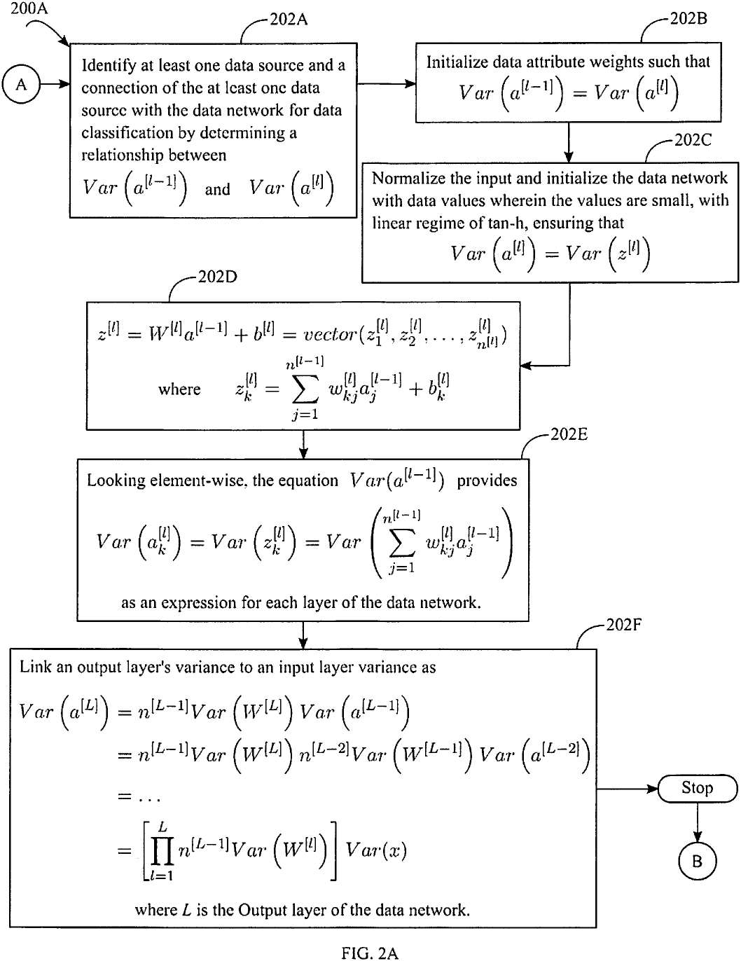

Referring to FIGS. 2 and 2A, flowcharts 200 and 200A depicting a data processing method for executing a task and data classification in an enterprise application is provided in accordance with an embodiment of the invention. The method includes the steps of 201 receiving an input for executing a task at a server. In 202, identifying and fetching by the one or more processors coupled to an AI engine, one or more outliers from a data network based on the task to be executed, wherein a bot generates one or more data scripts for identifying the outliers by utilizing a library of functions stored on a functional database. In 203, processing the one or more outliers by at least one outlier data model trained on a historical outlier dataset to identify one or more glitches in execution of the task and recommend at least one action to obviate the one or more glitches for executing the task. In step 204, in response to the recommended action, determining by at least one path identifier data model, at least one path for execution of the action, wherein the path identifier data model is trained on a historical execution path dataset to create an autogenerated execution path.

In an embodiment, the outliers include deviations in system such as absence of documents like invoice, contracts etc. The outliers may also include rearrangement of processing sequence for e.g.: a payment is initiated without verification of an invoice as the invoice wasn’t generated and the payment was being in processed based on the PO. The outliers may also include absence of approver, or absence or error in verification of security certificates of the blockchain network. The data network and blockchain network enable identification of the outliers of different types in the enterprise application, thereby enabling the data processing system to identify the glitches and recommend action to obviate the glitches.

In an embodiment, the recommended action includes an alternate approver to execute an approval flow task in the enterprise application, an alternate approval path based on the learning from the historical data, correcting processing of transactions based on analysis of the rearranged processing sequence, identifying and fetching an absent document from different data source through the data network, and verifying security certificates based on historical data from the blockchain network. The system identifies the glitches from the outliers in executing the task, where the glitches may include processing protocols established for processing data as per a set sequence, the glitch may also include in case of absence of approver the system is not configured to reassign the approval to another approver etc.

In an embodiment, the task includes execution of approval mechanism in one or more SCM application functions including contract management, inventory management, warehouse management, sourcing, finance management, and functions that require approval for execution of the task.

In another embodiment, the task includes verification of security mechanism in one or more SCM application functions where the blockchain implemented client node and server node configuration needs to be verified to ensure secured communication. In case of an outlier or deviation in the security certificate or characteristic data of the client node, the data processing system identifies the glitch like expiry of security certificate or digital certificate, and the system recommends an action to verify the client node and the transaction based on historical security certificate data in case the glitch has occurred recently, to ensure the processing of the functions of the EA are not disrupted.

In an embodiment, the received input data is a user input received through the interface or an input received from the one or more SCM application function that auto-triggers the task to be executed. Also, the one or more data scripts are backend scripts created by the bot based on the received input and AI processing for enabling automation of identifying the outlier.

In a related embodiment, the data processing system includes a data extraction process for extracting one or more data attributes associated with the input data. The data extraction process includes the steps of identifying a type of input data and sending the data to at least one data recognition training model for identification of the one or more data attribute wherein the data recognition training model processes the data based on prediction analysis by a bot for obtaining the data attribute.

In a related embodiment, a document recognizer utilizes unsupervised learning to understand a layout and relationship between fields and entries in the data.

In an exemplary embodiment, the data processing method of the invention processes the input data based on the at least one outlier data model. The method includes step 203A of identifying one or more nodes of a tree set with one or more vertices. In step 203B, initializing one or more vertices distance value including source vertex distance. In step 203C, aligning a source vertex in a minimum priority queue as a composition in the queue is based on vertices distance. In step 203D, popping a vertex with minimum distance from the queue wherein initially the popped vertex is the source vertex, and in step 203E identifying a connection between the one or more identified nodes to determine presence or absence of an outlier.

In another exemplary embodiment, the data processing method of the invention processes the input data based on the at least one path identifier data model. The method includes step 204A of identifying one or more nodes of a tree set with one or more vertices. In step 204B, initializing one or more vertices distance values including source vertex distance. In step 204C, aligning a source vertex in a minimum priority queue as a composition in the queue is based on vertices distance. In step 204D, popping a vertex with minimum distance from the queue wherein initially the popped vertex is the source vertex, and in step 204E, determining if a first vertex distance (V_{d1}) and edge weight (Wₑ) is less than a second vertex distance (V_{d2}) [V_{d1} + Wₑ = V_{d2}] to update distances of connected vertices to the popped vertex wherein a vertex with a new distance is aligned to the priority queue.

In an embodiment, a transaction through a blockchain network is encrypted and the approval task in the one or more SCM application function is executed through the network. The blockchain network includes one or more data blocks connected to each other and configured for storing SCM application data and the blockchain network enables an integrator to integrate the AI engine with one or more external entity systems.

In a related embodiment, the transaction includes an approval flow transaction comprising an approver type, an approver profile information, a security certificate information associated with the approver, and an approval flow primary key corresponding to an approval flow public key.

In another related embodiment, an approval flow security transaction comprising the approval flow public key is recorded to the blockchain network to generate an approver record comprising the approver name, the approval flow public key, the security certificate information associated with the approver, and an associated identifier of the approver including an internet protocol (IP) address, wherein the approval flow security transaction is signed using the approval flow primary key.

In yet another embodiment, the data processing method includes initiating a secure communication between a client node and a sever node associated with the approval flow to execute the task using at least one of the approval flow public key and the security certificate information associated with the approver.

In an embodiment, the data processing method includes identifying one or more approvers for executing an approval flow, wherein the one or more processors coupled to the AI engine are configured to identify the one or more approvers based on one or more parameters including authorization, permission to SCM document as per data access control policy defined as a data matrix of organization, line of operation, entity type including supplier, buyer, category of operation, region of operation, and document type wherein a relation between the approver and the parameters is evaluated from the data network.

FIG. 2A is a flowchart 200A depicting a data processing method with data classification in accordance with an embodiment of the invention. The output of a neural network would be to understand what kind of data source and how it is connected to the data network and feed to the data classifier.

In an example embodiment, the input data would include the code:

{“_id”:“FE06CC65-F840-4856-B01E-8BEB5A8734DF”, “lstApprovalProcess”:
[{“argInstanceId”:“FE06CC65-F840-4856-B01E-8BEB5A8734DF”, “argDocumentCode”:1600,
“argDocumentAmt”:10,“argAdditionalText”:“”,“argEventName”:“OnSubmit”,
“argUserExecutionContext”: {“Activities”:“”,“UserId”:“479044”,“IsSupplier” :false,“ SupplierPart
nerCode”:“0”,“Culture”:“en-US”},“argRequesterDV”:“0”,“argIsProcessed”:“false”,
“argActiveApproverType”:“”,“argActiveApprovalType”:“”,“argApprovalBasedOn”:“”,“argIsLea
dApprovalRequired”:“”,“argDocumentTypeId”:1,“GroupId”:3,“argActiveWFOrderId”:0,“argHie
rarchyId”:0,“argParentHierarchyId”:0,“argIsSkipped”:false,“argSkipType”:0,“argIsOfflineAppro
ved” :false,“argDeploymentRegionId” : “ 1”}

Now considering a layer 1 with a forward propagation of:

$${a}^{\left[l - 1\right]} = {g}^{\left[l - 1\right]} \left({z}^{\left[l - 1\right]}\right)$$

$${z}^{\left[l\right]} = {W}^{\left[l\right]} {a}^{\left[l - 1\right]} + {b}^{\left[l\right]}$$

$${a}^{\left[l\right]} = {g}^{\left[l\right]} \left({z}^{\left[l\right]}\right)$$

The recommended initialization for every layer l:

$$\begin{matrix}{W}^{\left[1\right]} ∼ N \left(μ = 0 , {σ}^{2} = \frac{1}{{n}^{\left[l - 1\right]}}\right) \\ {b}^{\left[l\right]} = 0\end{matrix}$$

The one or more processors is coupled to a data classifier to identify at least one data source and a connection of the at least one data source with the data network for data classification by determining a relationship between Var(a^{[l-1]}) and Var(a^{[l]}) as:
initializing data attribute weights such that Var(a^{[l-1]}) = Var(a^{[l]});
normalizing the input and initializing the data network with data values wherein the data values are small with linear regime of tan-h ensuring Var(a^{[l]}) = Var(z^{[l]});
$$\begin{matrix}{z}^{\left[l\right]} = {W}^{\left[l\right]} {a}^{\left[l - 1\right]} + {b}^{\left[l\right]} = v e c t o r \left({z}_{1}^{\left[l\right]} , {z}_{2}^{\left[l\right]} , ... , {2}_{n \left[l\right]}^{\left[l\right]}\right) \text{where} {2}_{k}^{\left[1\right]} = \\ {\sum }_{j = 1}^{{n}^{\left[l - 1\right]}} {w}_{k j}^{{}^{\left[l\right]}} {a}_{j}^{\left[l - 1\right]} + {b}_{j}^{\left[l\right]} ,\end{matrix}$$
looking element-wise equation Var(a^{[l-1]})=Var(a^{[l]})Var(a[l-1])=Var(a[l]) provides [symbol] as an expression for each layer of the data network; and
linking an output layer’s variance to an input layer variance as
$$\begin{matrix}{V}_{a r} \left({a}^{\left[L\right]}\right) = {n}^{\left[L - 1\right]} {V}_{a r} \left({W}^{\left[L\right]}\right) {V}_{a r} \left({a}^{\left[L - 1\right]}\right) \\ = {n}^{\left[L - 1\right]} {V}_{a r} \left({W}^{\left[L\right]}\right) {n}^{\left[L - 2\right]} {V}_{a r} \left({W}^{\left[L - 1\right]}\right) {V}_{a r} \left({a}^{\left[L - 2\right]}\right) \\ = ... \\ = \left[{\prod }_{l = 1}^{L} {n}^{\left[l - 1\right]} {V}_{a r} \left({W}^{\left[l\right]}\right)\right] {V}_{a r \left(x\right)}\end{matrix}$$
where, “L” is Output layer of the data network;
z is input attribute 1;
b is input attribute 2;
a is forward propagation of initial inputs;
j,k,l,n are integers;
w is a matrix of size that feeds input in loop.

In an embodiment, the at least one data source includes a master data, inventory, order, RFX, ASN, supplier, contracts, user, IOT device, invoice retailers, suppliers, demand drivers, distributers, clients, logistics companies, third party manufacturers or mobile and IOT device management companies, channel & marketing partners, customer feedback collectors including social sentiments, survey management companies, entities including sales data, sensors data from manufacturing plant, sensors bit info from logistics, sensors data from warehouse management on item location, item tracker entities, feedback from end customers through bloggers, feedback data from channel partners, purchase Order data from enterprise systems, invoices and sales order from customers, external entities including global economy, market indices details, inventory stock from warehouse, contract management, shipping notes, invoice, sourcing, or any data generating module associated with a supply chain function of an enterprise application (EA).

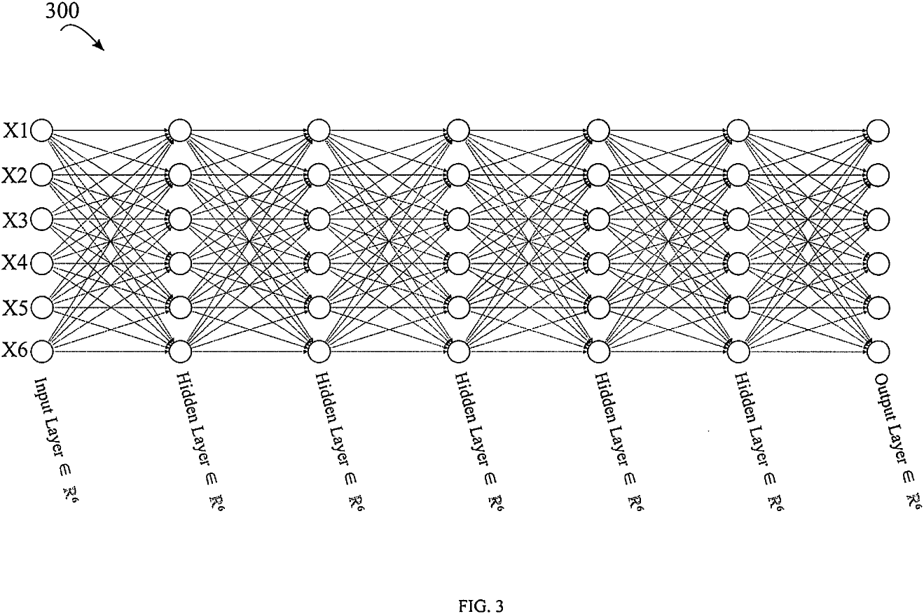

Referring to FIG. 3 is a neural network 300 of the data processing system is provided in accordance with an embodiment of the invention. The data processing method includes training the at least one outlier data model and the at least one path identifier data model using the neural network configured for data classification, the neural network obtained as output of the relationship determined between Var(a^{[l-1]}) and Var(a^{[l]}).

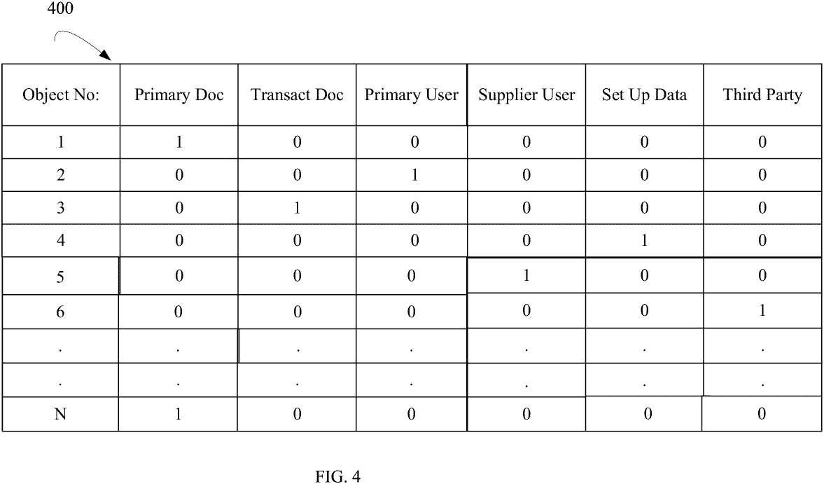

FIG. 4 is a table 400 showing an output of the neural network in accordance with an embodiment of the invention. The output includes primary document data, transactional data document, a primary user, a Supplier user, Setup data and third-party data objects. For multiple third-party data objects being passed, the output would be as shown in the table 400.

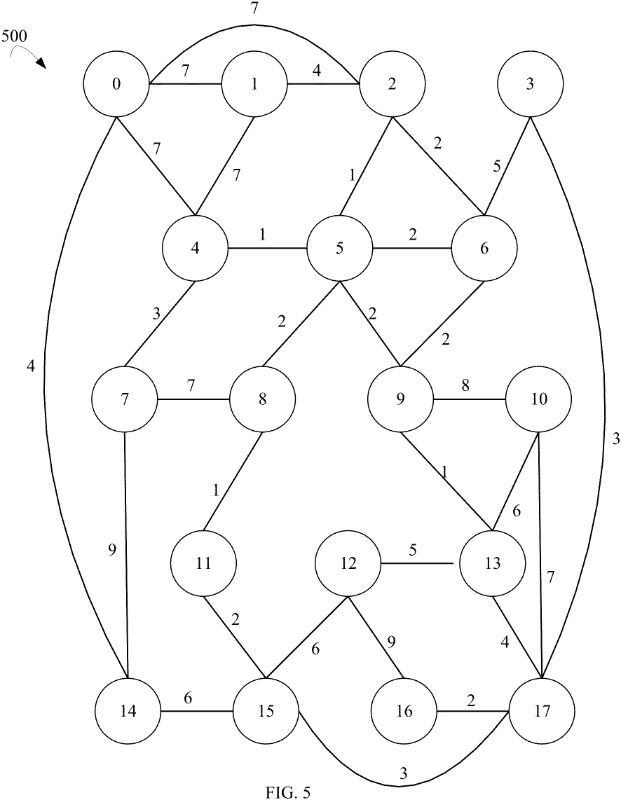

In an example embodiment, the shortest path identifier is implemented with say 18 nodes that are identified as a special tree set. FIG. 5 is a graph network 500 showing the paths from each of the 18 nodes of the network. The input for path identifier is the start and end nodes of the graph. The code for implementing the path identifier includes creating a set sptSet (shortest path tree set) that keeps track of vertices included in shortest path tree, i.e., whose minimum distance from source is calculated and finalized. Initially, this set is empty and then assigning a distance value to all vertices in the input graph. Initializing all distance values as infinite and assigning distance value as 0 for the source vertex so that it is picked first. While sptSet doesn’t include all vertices, picking a vertex u [in this case node 1] which is not there in sptSet and has minimum distance value. Then including u to sptSet and updating distance value of all adjacent vertices of u. To update the distance values, iterating through all adjacent vertices. For every adjacent vertex v, if sum of distance value of u (from source) and weight of edge u-v, is less than the distance value of v, then update the distance value of v.

In an example embodiment, the code for the path identifier is further implemented with the algorithm as below:

class {// A utility function to find the vertex with minimum distance value, from the set of vertices
not yet included in shortest path tree:
static int V = 18;
int minDistance(int[] dist, bool[] sptSet)
{// Initialize min value
int min = int.MaxValue, min_index = -1;
for (int v = 0; v < V; v++)
if (sptSet[v] == false && dist[v] <= min)
{min = dist[v]; min_index = v;}
return min _index;}
// A utility function to print the constructed distance array
void printSolution(int [] dist, int n)
{Console.Write(“Vertex Distance ”+ “from Source\n”);
for (int i = 0; i < V; i++)
Console.Write(i + “ \t\t “ + dist[i] + “\n”); }
// Function that implements a single source shortest path algorithm for a graph represented using
adjacency matrix representation:
void (int[, ] graph, int src)
{int[] dist = new int[V];
// The output array. dist[i] will hold the shortest distance from src to i
// sptSet[i] will true if vertex i is included in shortest path tree or shortest distance from src to i is
finalized
bool [] sptSet = new bool[V];
// Initialize all distances as INFINITE and stpSet[] as false
for (int i = 0; i < V; i++)
{dist[i] = int.MaxValue; sptSet[i] = false;}
// Distance of source vertex from itself is always 0
dist[src] = 0;
// Find shortest path for all vertices
for (int count = 0; count < V - 1; count++)
{int u = minDistance(dist, sptSet);
sptSet[u] = true;
for (int v = 0; v < V; v++)
if (! sptSet[v] && graph[u, v] != 0 &&
dist[u] != int.MaxValue && dist[u] + graph[u, v] < dist[v])
dist[v] = dist[u] + graph [u, v];}
printSolution(dist, V);}
public static void Main()
{/* The example graph discussed above is created as*/
int[, ] graph = new int[, ] { { 0, 4, 0, 0, 0, 0, 0, 8, 0 }, { 4, 0, 8, 0, 0, 0, 0, 11, 0 },
{ 0, 8, 0, 7, 0, 4, 0, 0, 2 }, { 0, 0, 7, 0, 9, 14, 0, 0, 0 }, { 0, 0, 0, 9, 0, 10, 0, 0, 0 },
{ 0, 0, 4, 14, 10, 0, 2, 0, 0 }, {0, 0, 0, 0, 0, 2, 0, 1, 6 }, {8, 11, 0, 0, 0, 0, 1, 0, 7 },
{0, 0, 2, 0, 0, 0, 6, 7, 0 }};
GFG t = new GFG (); t.(graph, 0);} }

The expected output is as following:
The Shortest path for the nodes search to be met from 1 to all 18 nodes.
Shortest time taken and hidden anomalies identified which are avoided in the path.
Overall time taken for the shortest path taken.

It shall be apparent to a person skilled in the art that while the above algorithm describes one example of data classification and determining shortest path, there may be other algorithm that can be used to implement a similar functionality within the scope of this disclosure. The machine learning, Artificial Intelligence (AI) and NLP (natural language processing) techniques described in this disclosure are only for example and not the only way to implement the desired functionality.

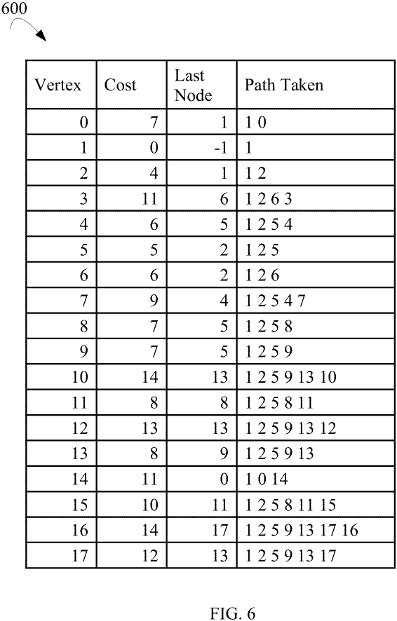

FIG. 6 is a table 600 showing shortest path for reaching from one node of the graph network to another node in accordance with an example embodiment of the invention. The table 600 takes the example of 18 nodes as shown in the graph structure 500 of FIG. 5. The table 600 provides, vertex, cost, last node, and the eventual path taken based on the graphical node structure.

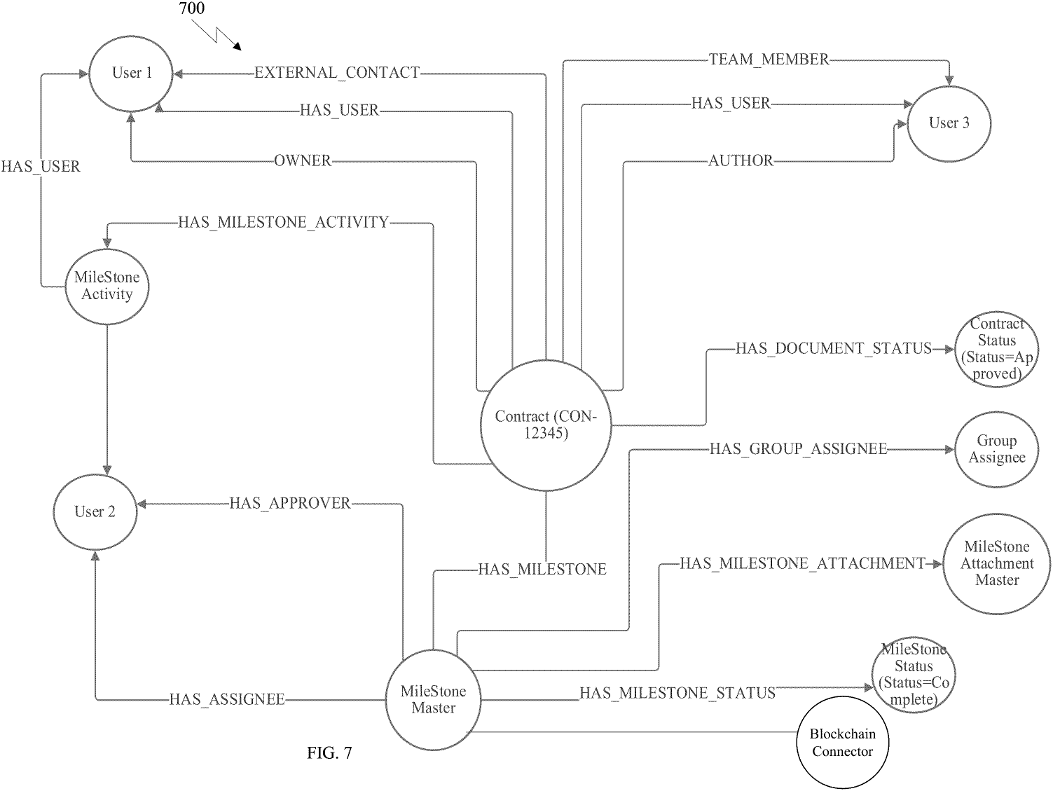

FIG. 7 is a data network 700 with contract lifecycle management (CLM) function data objects and nodes of the enterprise application in accordance with an example embodiment of the invention. The data network 700 provides representation of CLM data object having various data element nodes of specific data object say a contract, with data attributes like contract number and data element as CON-12345. The Network 700 also includes Status (Approved), Contract Milestones, Status of each milestone, and Users (user 3) associated for this contract. Further the network 700 provides a block chain connector for connection to a blockchain network for establishing a secured communication while executing the task.

In an example embodiment, the data processing system is configured to split one approval request to make changes to a user profile, into multiple approval workflows for “sub-version” of a change request such that every field is approved by the assigned approver. Considering the case of a supplier change request, a user comes onto the supplier profile and makes changes to the following: a) the Supplier name and DBA fields of the Basic Details section; b) the RFx Format and Contract Format fields of the Transaction Type section; c) the Diversity Section fields; d) the Identification section grid. Now assuming the change request approval rules are configured in approval UI (user interface) as: Rule 1: Changes to the Supplier Name goes to Approver A; Rule 2: Changes to Basic details section go to Approver B; Rule 3: Changes to Contract Format field goes to Approver C; Rule 4: Default Approver for the entire Supplier Profile is Approver D. The evaluation of the rules occurs at 3 stages including field level, section level and default profile level, such that the system creates 4 sub-versions for the change request that is submitted. The sub versions include: (i) Change request (CR) Version 1.1 - Field level evaluation will identify that there is a Rule for Supplier name and hence the evaluation will stop for that field and will create a CR version for it going to Approver A; (ii) CR Version 1.2 - Field level evaluation will not give any matches as there is no rule for DBA field, Section level evaluation will find a rule for the Basic Details section and hence will create a CR version for it going to Approver B; (iii) CR Version 1.3 - Field level evaluation for Contract format will find a rule and create a CR version triggered to Approver C; (iv) CR Version 1.4 - Field level evaluation will not give any matches as there is no rule for RFx format or the other updated fields from the Diversity and Identification section, Section Level evaluation will not give any matches as there is no rule for Transaction Type, Diversity or Identification Section, and as there is a Default rule for the Profile, a CR version will be created for these fields going to Approver D. To achieve the above, the data processing system is configured to run the rules for Field level/section level and Profile level separately, identify which rule (and rule details like parameters of rule) caused the selection of which approver to split the right fields of the change request to the right approver, invoking and parallelly running multiple approval flows based on the outcome of the above evaluations for the different CR sub-versions independently.

In an advantageous aspect, the data processing system is configured to auto-re-process by the Artificial intelligence (AI) model. For every document that slipped through the cracks due to a valid scenario like the rule being setup wrong or there was an unidentified interruption, then AI engine has the capability to find out where the document failed, either in code or infra and reprocess the document automatically within mins of the failure, which helps improve the user experience. Further, the system includes an active ledger as part of the blockchain within the approval flow. The system enables integration with external party for approvals. The system has the capability to integrate with all third-party approval systems, and as trust is an issue, the data processing systems internal ledger can establish trust within all approval parties.

In another advantageous aspect, the data processing system employs an efficient processing mechanism to ensure faster processing with same computing resources. The system builds AI data models with data classification by neural network, then the classified data is fed to the model which executed data analysis with multiple algorithms. The input data is fed to the models and the AI engine for outlier identification and recommendation for resolving the outlier, identifying least resistant path, predicting overall document flow, expected approval time, and fraud detection.

In an exemplary embodiment, the present invention may be a data processing system, a method, and/or a computer program product. The computer program product may include a computer readable storage medium (or media) having computer readable program instructions thereon for causing a processor to carry out aspects of the present invention. The media has embodied therein, for instance, computer readable program code (instructions) to provide and facilitate the capabilities of the present disclosure. The article of manufacture (computer program product) can be included as a part of a computer system/ computing device or as a separate product.

The computer readable storage medium can retain and store instructions for use by an instruction execution device i.e. it can be a tangible device. The computer readable storage medium may be, for example, but is not limited to, an electromagnetic storage device, an electronic storage device, an optical storage device, a semiconductor storage device, a magnetic storage device, or any suitable combination of the foregoing. A non-exhaustive list of more specific examples of the computer readable storage medium includes the following: a hard disk, a random access memory (RAM), a portable computer diskette, a read-only memory (ROM), a portable compact disc read-only memory (CD-ROM), an erasable programmable read-only memory (EPROM or Flash memory), a digital versatile disk (DVD), a static random access memory (SRAM), a floppy disk, a memory stick, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the internet, a local area network (LAN), a wide area network (WAN) and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

The foregoing is considered as illustrative only of the principles of the disclosure. Further, since numerous modifications and changes will readily occur to those skilled in the art, it is not desired to limit the disclosed subject matter to the exact construction and operation shown and described, and accordingly, all suitable modifications and equivalents may be resorted to that which falls within the scope of the appended claims.

1. A data processing system comprising:
one or more processors;
at least one memory device coupled to the one or more processors enabling the one or more processors to:
receive an input data for executing a task at a server;
identify and fetch by the one or more processor coupled to an artificial intelligence (AI) engine, one or more outliers from a data network based on the task to be executed wherein a bot utilizes a library of functions stored in a functional database to generate one or more data scripts usable by the one or more processors to identify the outliers;
process the one or more outliers by at least one outlier data model trained on a historical outlier dataset to identify one or more glitches in execution of the task and recommend at least one action to obviate the one or more glitches for executing the task; and
in response to the recommended action, determine by at least one path identifier data model, at least one path for execution of the action wherein the path identifier data model is trained on a historical execution path dataset to create an autogenerated execution path.

2. The system of claim 1, wherein the task includes execution of approval mechanism in one or more SCM application functions including contract management, inventory management, warehouse management, sourcing, finance management, and functions that require approval for execution of the task.

3. The system of claim 2, wherein the received input data is a user input received through an interface or an input received from the one or more SCM application functions that auto-triggers the task to be executed.

4. The system of claim 3, wherein the one or more data scripts are backend scripts created by the bot based on the received input and AI processing for enabling automation of identifying the one or more outliers.

5. The system of claim 4, further comprising:
a blockchain network having one or more data blocks connected to each other and configured for storing SCM application data; and
an integrator configured to integrate the AI engine with one or more external entity systems through the blockchain network, wherein a transaction through the blockchain network is encrypted using a random number and the approval mechanism in the one or more SCM application functions is executed through the blockchain network.

6. The system of claim 5, wherein the blockchain network comprises a plurality of blockchain node layers, wherein the node layers include a client node layer, a server node layer and a plurality of data network node layers.

7. The system of claim 6, wherein the one or more processors are configured to determine fraud based on processing of the received input by the AI engine through a fraud detection algorithm.

8. The system of claim 7, wherein the data network comprises:
one or more data element nodes configured to create one or more sub-networks through a graphical data structure, wherein one or more data elements are extracted from one or more data objects for analysis to identify the one or more data elements to be ingested as one or more data element nodes of the data network; and
one or more data connectors of the graphical data structure configured for connecting the one or more data element nodes to form the data network, wherein the one or more data connectors include at least one identifier configured to identify the one or more data element nodes of the data network based on at least one relationship between one or more data attributes associated with the one or more data objects and one or more historical data elements, wherein the one or more data connectors include information about the one or more outliers.

9. The system of claim 8, wherein the one or more processors are coupled to a data classifier to identify at least one data source and a connection of the at least one data source with the data network for data classification by determining a relationship between Var(a^{[l-1]}) and Var(a^{[l]}). as:
initializing data attribute weights such that Var(a^{[l-1]})= Var(a^{[l]});
normalizing the input and initializing the data network with data values wherein the data values are small with linear regime of tan-h ensuring ;
$${z}^{\left[l\right]} = {W}^{\left[l\right]} {a}^{\left[l - 1\right]} + {b}^{\left[l\right]} = v e c t o r \left({z}_{1}^{\left[l\right]} , {z}_{2}^{\left[l\right]} , … , {z}_{n}^{\left[l\right]}\right)$$
where
$${z}_{k}^{\left[l\right]} = {\sum }_{j = 1}^{{n}^{\left[l - 1\right]}} {w}_{k j}^{\left[l\right]} {a}_{j}^{\left[l - 1\right]} + {b}_{k}^{\left[l\right]} . ;$$
looking element-wise equation Var(a^{[l-1]})=Var(a^{[l]})
Var(a[l-1])=Var(a[l]) provides
$$V a r \left({a}_{k}^{\left[l\right]}\right) = V a r \left({z}_{k}^{\left[l\right]}\right) = V a r \left({\sum }_{j = 1}^{{a}^{1 - ε}} {w}_{k j}^{\left[l\right]} {a}_{j}^{\left[l - 1\right]}\right)$$
as an expression for each layer of the data network; and
linking an output layer’s variance to an input layer variance as
$$\begin{matrix}V a r \left({a}^{\left[L\right]}\right) = {n}^{\left[L - 1\right]} V a r \left({W}^{\left[L\right]}\right) V a r \left({a}^{\left[L - 1\right]}\right) \\ = {n}^{\left[L - 1\right]} V a r \left({W}^{\left[L\right]}\right) {n}^{\left[L - 2\right]} V a r \left({W}^{\left[L - 1\right]}\right) V a r \left({a}^{\left[L - 2\right]}\right) \\ = … \\ = \left[{\prod }_{i = 1}^{L} {n}^{\left[l - 1\right]} V a r \left({W}^{\left[l\right]}\right)\right] V a r \left(x\right)\end{matrix}$$
where, “L” is Output layer of the data network;
z is input attribute 1;
b is input attribute 2;
a is forward propagation of initial inputs;
j,k,l,n are integers;
w is a matrix of size that feeds input in loop.

10. The system of claim 9, further comprising a neural network obtained as output of the relationship determined between Var(a^{[l-1]}) and Var(a^{[l]}), wherein the neural network is configured for data classification to train the at least one outlier data model and the at least one path identifier data model.

11. The system of claim 10, wherein the one or more processors are configured to process the input data based on the at least one outlier data model by:
identifying one or more nodes of a tree set with one or more vertices;
initializing one or more vertices distance values including source vertex distance;
aligning a source vertex in a minimum priority queue as a composition in the queue is based on vertices distance;
popping a vertex with minimum distance from the queue wherein initially the popped vertex is the source vertex; and
identifying a connection between the one or more identified nodes to determine presence or absence of an outlier.

12. The system of claim 10, wherein the one or more processors are configured to process the input data based on at least one path identifier data model by:
identifying one or more nodes of a tree set with one or more vertices;
initializing one or more vertices distance values including source vertex distance;
aligning a source vertex in a minimum priority queue as a composition in the queue is based on vertices distance;
pop a vertex with minimum distance from the queue wherein initially the popped vertex is the source vertex; and
determining if a first vertex distance (V_{d1}) and edge weight (Wₑ) is less than a second vertex distance (V_{d2}) [V_{d1} + Wₑ = V_{d2}] to update distances of connected vertices to the popped vertex wherein a vertex with a new distance is aligned to the priority queue.

13. The system of claim 2, further comprising:
a data crawler and analyzer coupled to the one or more processor and configured for analyzing one or more documents related to the SCM application function to identify a plurality of data items of the one or more documents requiring approvals for executing the function wherein each of the plurality of data items have an approval flow such that an outcome of the approval flow of a first data item of the plurality of data items impacts the approval flow of a second data item of the plurality of data items.

14. The system of claim 13, wherein the one or more processors are configured to identify an approval type based on the data items, wherein the data items are structured in a hierarchy and the approval type is identified as single approval type or multi-approver type by the AI engine based on one or more configured processing rules.

15. The system of claim 14, further comprising a control unit encoded with instructions enabling the control unit to function as a bot for processing the approval flow to execute the SCM function, wherein the plurality of data items for approvals creates a parent-child approval flow.

16. The system of claim 15, wherein the parent-child approval flow includes distinct weightage dynamically assigned by the AI engine to each of the one or more child approval flow node thereby enabling the one or more processors to process the approval flow with the shortest approval path, wherein one or more approval constraint associated with each of the one or more child approval flow node decides execution of the SCM function.

17. The system of claim 16, wherein the one or more approval constraints include approval data attributes associated with one or more approvers of the parent-child approval flow determining probability of receiving an approval from the one or more approvers.

18. A method of data processing comprising:
receiving an input for executing a task at a server;
identifying and fetching by the one or more processors coupled to an AI engine, one or more outliers from a data network based on the task to be executed, wherein a bot generates one or more data scripts for identifying the outliers by utilizing a library of functions stored on a functional database;
processing the one or more outliers by at least one outlier data model trained on a historical outlier dataset to identify one or more glitches in execution of the task and recommend at least one action to obviate the one or more glitches for executing the task; and
in response to the recommended action, determining by at least one path identifier data model, at least one path for execution of the action, wherein the path identifier data model is trained on a historical execution path dataset to create an autogenerated execution path.

19. The method of claim 18, wherein the task includes execution of approval mechanism in one or more SCM application functions including contract management, inventory management, warehouse management, sourcing, finance management, and functions that require approval for execution of the task.

20. The method of claim 19, wherein the received input is a user input received through the interface or an input received from the one or more SCM application functions that auto-triggers the task to be executed.

21. The method of claim 20, wherein the one or more data scripts are backend scripts created by the bot based on the received input and AI processing for enabling automation of identifying the outlier.

22. The method of claim 21, wherein a transaction through a blockchain network is encrypted and the approval in the one or more SCM application functions is executed through the network wherein, the blockchain network includes one or more data blocks connected to each other and configured for storing SCM application data and the blockchain network enables an integrator to integrate the AI engine with one or more external entity systems.

23. The method of claim 22, wherein the transaction includes an approval flow transaction comprising an approver type, an approver profile information, a security certificate information associated with the approver, and an approval flow primary key corresponding to an approval flow public key.

24. The method of claim 23, wherein an approval flow security transaction comprising the approval flow public key is recorded to the blockchain network to generate an approver record comprising the approver name, the approval flow public key, the security certificate information associated with the approver, and an associated identifier of the approver including an internet protocol (IP) address, wherein the approval flow security transaction is signed using the approval flow primary key.

25. The method of claim 24, further comprises:
initiating a secure communication between a client node and a sever node associated with the approval flow to execute the task using at least one of the approval flow public key and the security certificate information associated with the approver.

26. The method of claim 25, wherein the one or more processors is coupled to a data classifier to identify at least one data source and a connection of the at least one data source with the data network for data classification by determining a relationship between Var(a^{[l-1]}) and Var(a^{[l]}). as:
initializing data attribute weights such that Var(a^{[l-1]}) = Var(a^{[l]});
normalizing the input and initializing the data network with data values wherein the data Var(a^{[l]}) = Var(z^{[l]}) values are small with linear regime of tan-h ensuring ;
looking element-wise equation Var(a^{[l-1]})=Var(a^{[l]})
Var(a[l-1])=Var(a[l]) provides
$$V a r \left({a}_{b}^{\left[l\right]}\right) = V a r \left({z}_{k}^{\left[l\right]}\right) = V a r \left({\sum }_{j = 1}^{{a}^{\left[1 - e\right]}} {w}_{k j}^{\left[l\right]} {a}_{j}^{\left[l - 1\right]}\right)$$
as an expression for each layer of the data network; and
linking an output layer’s variance to an input layer variance as
$$\begin{matrix}V a r \left({a}^{\left[L\right]}\right) = {n}^{\left[L - 1\right]} V a r \left({W}^{\left[L\right]}\right) V a r \left({a}^{\left[L - 1\right]}\right) \\ = {n}^{\left[L - 1\right]} V a r \left({W}^{\left[L\right]}\right) {n}^{\left[L - 2\right]} V a r \left({W}^{\left[L - 1\right]}\right) V a r \left({a}^{\left[L - 2\right]}\right) \\ = … \\ = \left[{\prod }_{i = 1}^{L} {n}^{\left[l - 1\right]} V a r \left({W}^{\left[l\right]}\right)\right] V a r \left(x\right)\end{matrix}$$
where, “L” is Output layer of the data network;
z is input attribute 1;
b is input attribute 2;
a is forward propagation of initial inputs;
j,k,l,n are integers;
w is a matrix of size that feeds input in loop.

27. The method of claim 26, further comprising training the at least one outlier data model and the at least one path identifier data model using a neural network configured for data classification, the neural network obtained as output of the relationship determined between Var(a^{[l-1]}) and Var(a^{[l]}).

28. The method of claim 27 wherein the input data is processed based on the at least one outlier data model by:
identifying one or more nodes of a tree set with one or more vertices;
initializing one or more vertices distance value including source vertex distance;
aligning a source vertex in a minimum priority queue as a composition in the queue is based on vertices distance;
popping a vertex with minimum distance from the queue wherein initially the popped vertex is the source vertex; and
identifying a connection between the one or more identified nodes to determine presence or absence of an outlier.

29. The method of claim 28 wherein the input data is processed based on at least one path identifier data model by:
identifying one or more nodes of a tree set with one or more vertices;
initializing one or more vertices distance value including source vertex distance;
aligning a source vertex in a minimum priority queue as a composition in the queue is based on vertices distance;
popping a vertex with minimum distance from the queue wherein initially the popped vertex is the source vertex; and
determining if a first vertex distance (V_{d1}) and edge weight (Wₑ) is less than a second vertex distance (V_{d2}) [V_{d1} + Wₑ = V_{d2}] to update distances of connected vertices to the popped vertex wherein a vertex with a new distance is aligned to the priority queue.

30. The method of claim 29 further comprising analyzing one or more documents related to the one or more SCM application functions by a data crawler and analyzer to identify a plurality of data items of the one or more documents requiring approvals for executing the function wherein each of the plurality of data items have an approval flow such that an outcome of the approval flow of a first data item of the plurality of data items impacts the approval flow of a second data item of the plurality of data items.

31. The method of claim 30, further comprising processing, using a control unit encoded with instructions enabling the control unit to function as a bot, the approval flow to execute an SCM function, wherein the plurality of data items for approvals creates a parent-child approval flow.

32. The method of claim 31, wherein the parent-child approval flow includes distinct weightage dynamically assigned by the AI engine to each of the one or more child approval flow node thereby enabling the one or more processors to process the approval flow with the shortest approval path wherein one or more approval constraint associated with each of the one or more child approval flow node decides execution of the SCM function.

33. The method of claim 32 further comprising:
identifying one or more approvers for executing an approval flow, wherein the one or more processors coupled to the AI engine are configured to identify the one or more approvers based on one or more parameters including authorization, permission to SCM document as per data access control policy defined as a data matrix of organization, line of operation, entity type including supplier, buyer, category of operation, region of operation, and document type wherein a relation between the approver and the parameters is evaluated from the data network.

34. A non-transitory computer program product for data processing, the computer program product comprising a non-transitory computer readable storage medium having instructions embodied therewith, the instructions when executed by one or more processors causes the one or more processors to:
receive an input for executing a task at a server;
identify and fetch, using an AI engine coupled to the one or more processors, one or more outliers from a data network based on the task to be executed, wherein a bot generates one or more data scripts created for identifying the outliers by utilizing a library of functions stored on a functional database;
process the one or more outliers by at least one outlier data model trained on a historical outlier dataset to identify one or more glitches in execution of the task and recommend at least one action to obviate the one or more glitches for executing the task; and
in response to the recommended action, determine by at least one path identifier data model, at least one path for execution of the action wherein the path identifier data model is trained on a historical execution path dataset to create autogenerated execution path.
